(19) United States
(12) Patent Application Publication
(10) Pub. No.: US 2003/0088446 A1
(43) Pub. Date: May 8, 2003

(54) System for assessing the risk of projects

(76) Inventors: Mary B. Phelps, Memphis, TN (US); William F. Cooney, Niskayuna, NY (US)

Correspondence Address: PERKINS COIE LLP, PATENT-SEA, P.O. BOX 1247, SEATTLE, WA, 98111-1247, US

(21) Appl. No.: 09/900,489

(22) Filed: Jul. 5, 2001

(51) Int. Cl. G06F 17/60

(52) U.S. Cl. 705/7

(57) ABSTRACT

A method and system for assessing risk associated with a project. The risk assessment system provides rules for various risk factors of risk types that are used to determine which risk factors of that risk type may be high. The risk assessment system also provides mitigating factors for the various risk factors. The risk assessment system receives information describing various projects. The information includes the data relating to each of the risk types. To assess the risk of a project, the risk assessment system identifies the risk factors that have a high risk by applying the rules to the data associated with that risk type. After the high risk factors are identified, the risk assessment system then identifies mitigating factors that apply to the high risk factors.

### BACKGROUND

The described technology relates generally to analysis of contractual terms and particularly to a computer system that automatically identifies high risk contractual terms.

Many companies and their customers use very detailed written contracts to specify the terms of their agreements to provide products or services. These contracts often need to be tailored to meet the specific needs of the customer. Large companies may have thousands of customers each with multiple contracts relating to various products and services that are provided by that company to the customer. A company, of course, wants to ensure that the terms of the contract do not expose the company to unnecessarily high risks. For example, a customer may propose a delivery date of six months after the contract is executed and propose that the company pay significant penalties for delayed delivery. The company's representative who is negotiating with the customer may not realize that, based on recent experience, a six-month delivery period is unrealistic. If the company was to agree to the proposed term, then the company would likely incur the significant penalties.

To minimize the chances of entering into contracts with such high risk terms, companies often have a contract review process that allows for a risk assessment to be made before each contract is executed. A company typically has a risk assessment team whose job it is to meet periodically and assess the risks associated with each contract. Before the risk assessment team meets, several reports may be manually generated by risk assessment analysts who try to point out the high risk terms associated with each contract. The company may have a risk assessment analyst for each possible risk type. For example, a company may have both a financial risk assessment analyst whose job it is to identify whether the financial terms present a high risk and a design risk assessment analyst whose job it is to identify whether the design of the proposed product presents a high risk. The risk assessment analyst may also suggest ways in which the terms of the contract can be modified to reduce the risk. When the risk assessment team meets, it analyzes the various risk assessment reports and determines whether the contract is acceptable, acceptable with modifications, or unacceptable. The majority of the proposed contracts may use only standard contractual terms and thus, the proposed contracts are acceptable. The risk assessment team may, however, devote a significant amount of time deciding whether such proposed contracts are acceptable. In addition, each risk assessment analyst may apply different standards when assessing the risk of a term, may present their report in a very different format, may suggest very different modifications to the proposed contracts, and so on. Because of this lack of uniformity and because the reports are generated manually, it is difficult and time-consuming to assess the risk of proposed contracts.

It would be desirable to have a risk assessment system that would help automate the process of assessing the risk of proposed contracts and projects in general, would provide uniformity in risk assessment, and would help speed up the process of risk assessment.

### BRIEF DESCRIPTION OF THE DRAWINGS

FIG. 1 is a display page used to collect general information describing a project.

FIG. 2 is a display page used to collect detailed information describing a project.

FIGS. 3 and 4 are display pages used to collect noise-related data.

FIG. 5 is a display page illustrating the results of the analysis of noise level risk factors in one embodiment.

FIG. 6 is a display page illustrating the mitigating factors associated with high risk factors in one embodiment.

FIG. 7 is a display page illustrating a risk report in one embodiment.

FIG. 8 illustrates components of the risk assessment system in one embodiment.

FIG. 9 is a block diagram illustrating the organization of the risk assessment database in one embodiment.

FIG. 10 is a block diagram illustrating various risk factor tables in one embodiment.

FIG. 11 is a block diagram illustrating components of the input will risk assessment component in one embodiment.

FIG. 12 is flow diagram illustrating the processing of the assess risk component in one embodiment.

FIG. 13 is a flow diagram illustrating the processing of an assess noise risk component in one embodiment.

FIG. 14 is a flow diagram illustrating the processing of the process near field guarantee component in one embodiment.

FIG. 15 is a flow diagram illustrating the processing of the process far field guarantee component in one embodiment.

FIG. 16 is a flow diagram illustrating the processing of the process special noise guarantee component in one embodiment.

FIG. 17 is a flow diagram illustrating the processing of the calculate far field value component in one embodiment.

FIG. 18 is a flow diagram illustrating processing of the identify mitigating factors component in one embodiment.

### DETAILED DESCRIPTION

A method and system for assessing risk associated with a project is provided. In one embodiment, the risk assessment system provides rules for various risk factors of risk types that are used to determine which risk factors of that risk type may be high. For example, a risk type may be financial and a risk factor may be a delayed delivery penalty. The rule may indicate that a delayed delivery penalty with a delivery date within six months may be a high risk. The risk assessment system also provides mitigating factors for the various risk factors. A mitigating factor indicates how the project may be modified (e.g., a contractual term changed) to help reduce the high risk of a risk factor. For example, a mitigating factor may indicate that the risk of the delayed delivery date may be mitigated when the penalty is less than one percent of the total contractual amount. The risk assessment system receives information describing various projects. The information includes the data relating to each of the risk types. To assess the risk of a project, the risk assessment system identifies the risk factors that have a high risk by applying the rules to the data associated with that risk type. After the high risk factors are identified, the risk assessment system then identifies mitigating factors that apply to the high risk factors. The risk assessment system can then generate a report that lists the high risk factors for each risk type and the mitigating factors. The risk assessment system may also allow a risk assessment analyst to comment on the risk factors and mitigating factors for a particular project. For example, the risk assessment analysts may suggest that other mitigating factors should be implemented. The risk assessment system may include the analysts' comments in the report that is provided to the risk assessment team. In this way, the risks associated with a project can be identified rapidly by applying uniform assessment standards and can be presented in a uniform format to the risk assessment team.

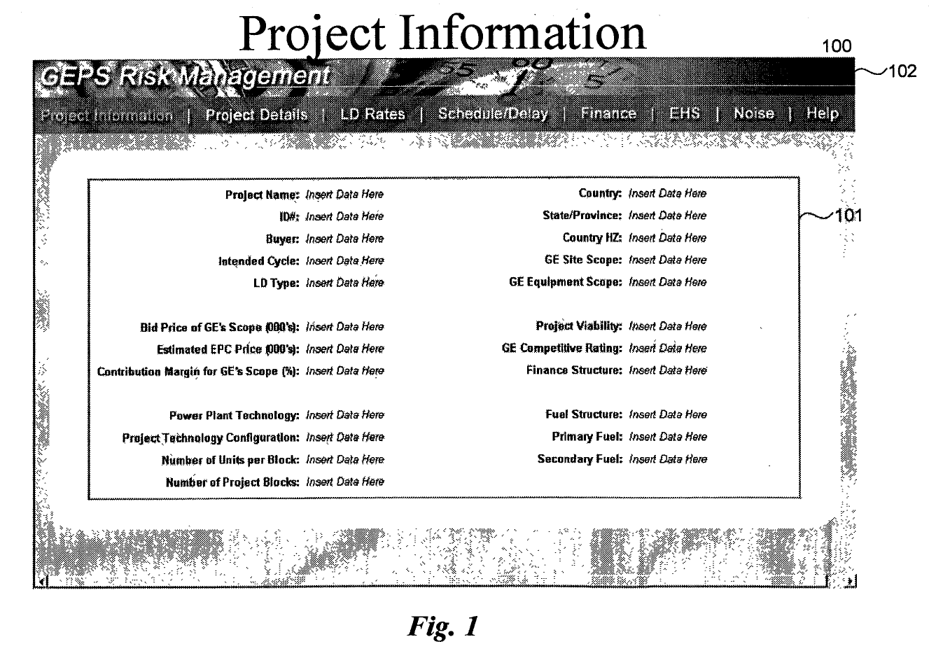

FIGS. 1-7 illustrate sample display pages of a risk assessment system in one embodiment. FIG. 1 is a display page used to collect general information describing a project. The example projects relate to contracts for providing power generation equipment, such as gas and steam turbines. One skilled in the art will, however, appreciate that the risk assessment system can be used to assess the risk associated with projects in virtually any industry. The display page 100 includes information entry fields 101 and risk type tabs 102. The information entry fields allow the user to provide general information about the project such as the project name, the project identifier, the customer name, the proposed price, the proposed products, and so on. The information entry fields can, of course, be tailored to the particular industry and needs of a company. When a user selects a risk type tab, the risk assessment system displays a display page through which the user can enter data relating to that risk type. In this example, the risk types include “LD rates,” “Schedule/Delay,” “Finance,” “EHS,” and “Noise.”

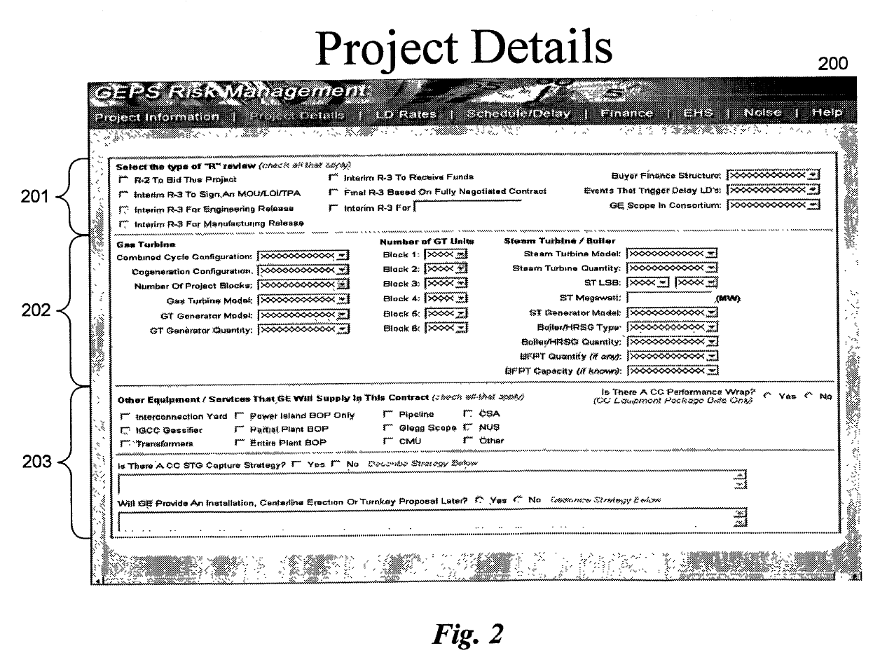

FIG. 2 is a display page used to collect detailed information describing a project. The display page 200 includes review type fields 201, product identification fields 202, and other equipment and services fields 203. The review type fields allow the user to specify the various types of review that may be needed for this project. For example, the project may require that the company's engineering department needs to approve of contracts of this type. The product identification fields allow the user to specify the product to be offered in the contract. For example, if the product is a gas turbine, then the product data may indicate whether the gas turbine is used in a combined cycle configuration and may include the model number of the gas turbine. The other equipment and services fields indicates miscellaneous equipment and services that the company will provide in conjunction with this contract.

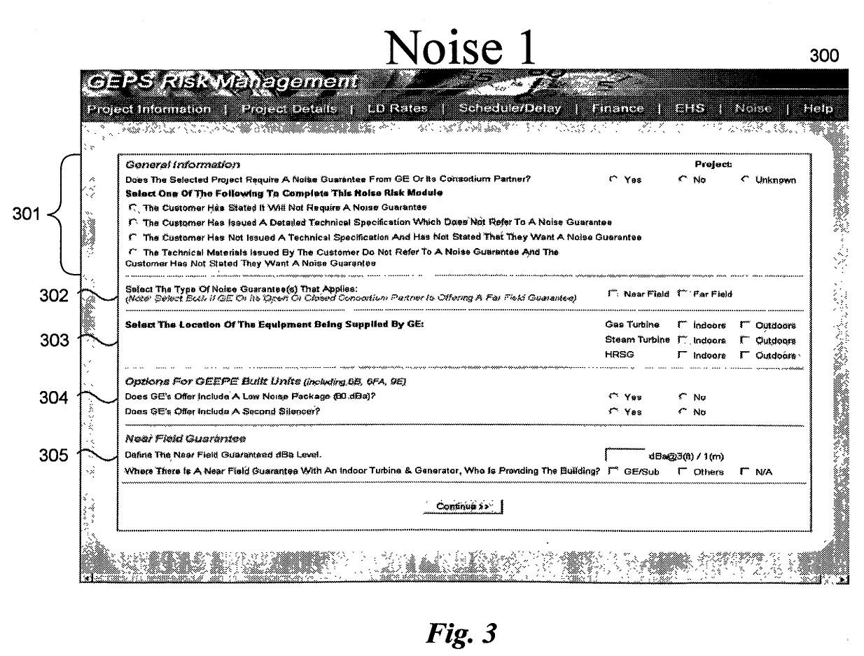

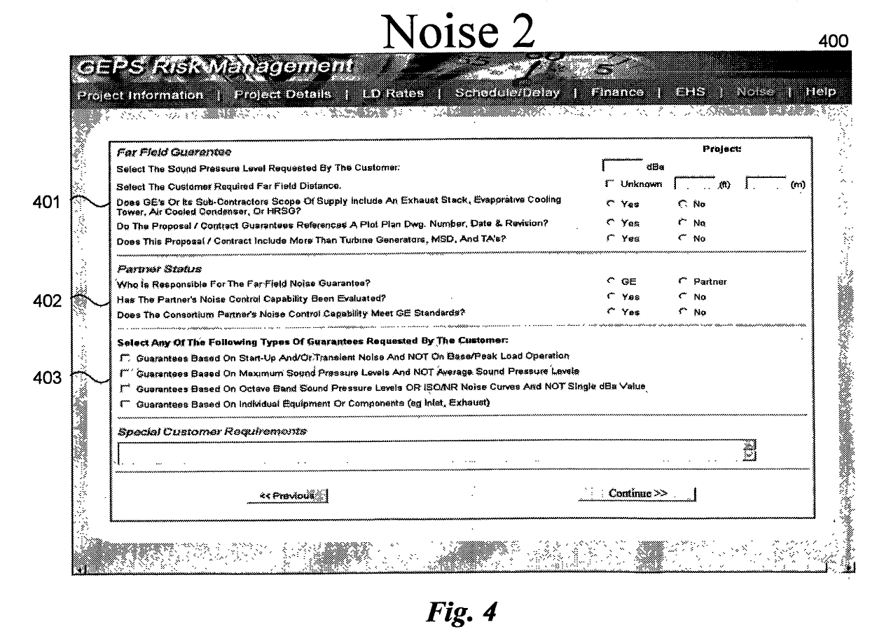

FIGS. 3- 8 illustrate the entry and analysis of data related to a noise risk type in one embodiment. FIGS. 3 and 4 are display pages used to collect noise-related data. The display page 300 includes a noise guarantee section 301, a near/far field section 302, an equipment location section 303, an options section 304, and a near field guarantee section 305. The display page 400 includes a far field guarantee section 401, a partner status section 402, and a customer-selected guarantee section 403. The noise guarantee section is used indicate whether the contract includes any guarantee as to the noise level. The near/far field section is used indicate if the contract includes a near and a far field guarantee. A near field guarantee specifies the maximum noise level near the equipment, and a far field guarantee specifies the maximum noise level at a certain distance from the equipment. The equipment location section specifies whether the equipment will be located indoors or outdoors. The options section indicates whether the contract includes various optional packages, such as a low noise package. The near field guarantee section specifies the guarantee of the near field noise level, if any. The far field guarantee section specifies the guarantee of the far field noise level, if any. The partner status section specifies whether a partner in the contract will be providing noise level guarantees. The customer-selected guarantee section specifies whether the contract proposes other noise level requirements requested by the customer, such as whether the customer would like a noise level guarantee on each of the components of the equipment (e.g., an inlet of a gas turbine). Although these display pages illustrate all the noise-related data that can be collected for a particular project in one embodiment, one skilled in the art will appreciate that not all the data need be collected for every project. For example, if the contract specifies that there is no near field noise level guarantee as indicated by the information entered in the near/far field section, then the risk assessment system would not display the near field guarantee section. When the user selects the continue button on the display page 400, the risk assessment system applies the rules for the risk factors of the noise level risk type to the enter data.

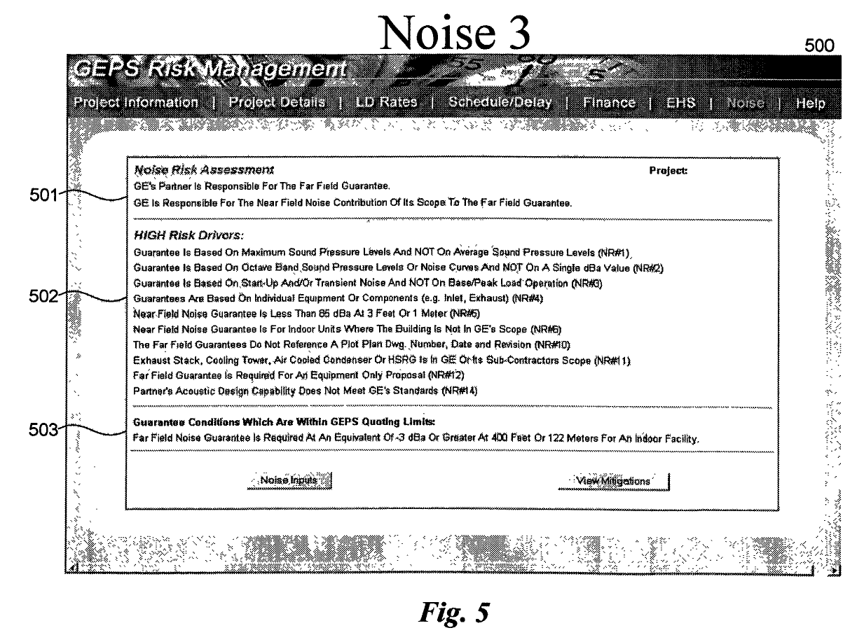

FIG. 5 is a display page illustrating the results of the analysis of noise level risk factors in one embodiment. The display page 500 includes a noise risk assessment section 501, a high risk drivers (or factors) section 502, and a guarantee conditions section 503. The noise risk assessment section highlights certain important features of the contract such as that the company is responsible for the guarantee of the far field noise level. The high risk drivers section lists the risk factors that the risk assessment system identified as being high risks. For example, a risk factor for a noise level risk type may be that the far field guarantee does not adequately identify the equipment layout using a plot plan drawing. Without such a drawing, it may be difficult to assess whether the far field noise level guarantee can be met. The guarantee conditions section highlights those risk factors identified as low risk because they are within acceptable risk.

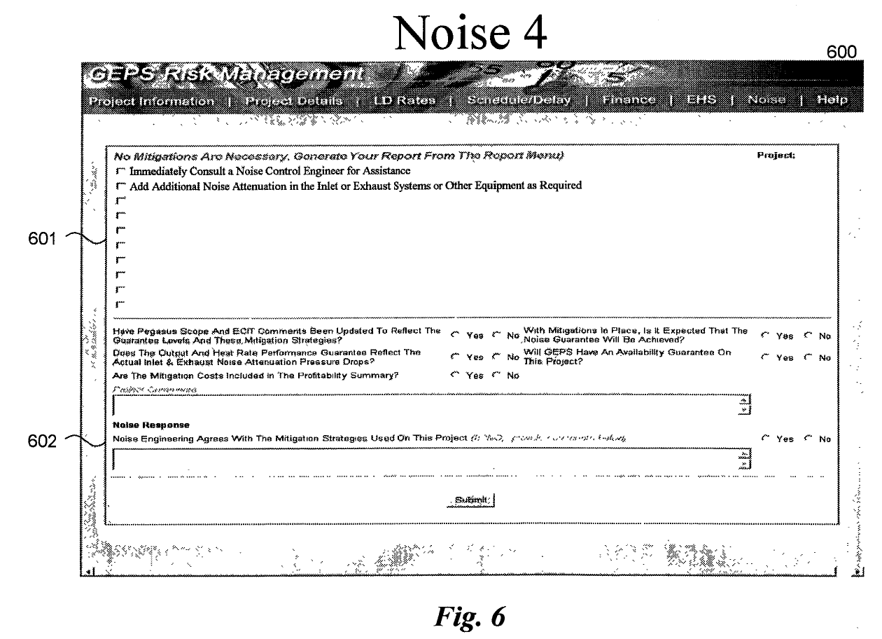

FIG. 6 is a display page illustrating the mitigating factors associated with high risk factors in one embodiment. A display page 600 includes a mitigating factor section 601 and a risk assessment analyst approval section 602. The mitigating factor section lists those mitigating factors for mitigating any of the high risk factors. For example, one mitigating factor may be that installation of additional noise attenuation equipment can be used to meet the far field noise level guarantee. The risk assessment analyst approval section indicates whether the analyst for the risk type (e.g., noise level) has approved of the related contractual terms. The analyst may view the risk assessment data, high risk factors, and mitigating factors in deciding whether to approve the contractual terms. The analyst may also add comments to the risk assessment data explaining their approval, disapproval, or suggestions for modifying the contractual terms. During the process of entering risk data the user or analyst may attach various documents and graphs to supplement the predefined risk data fields.

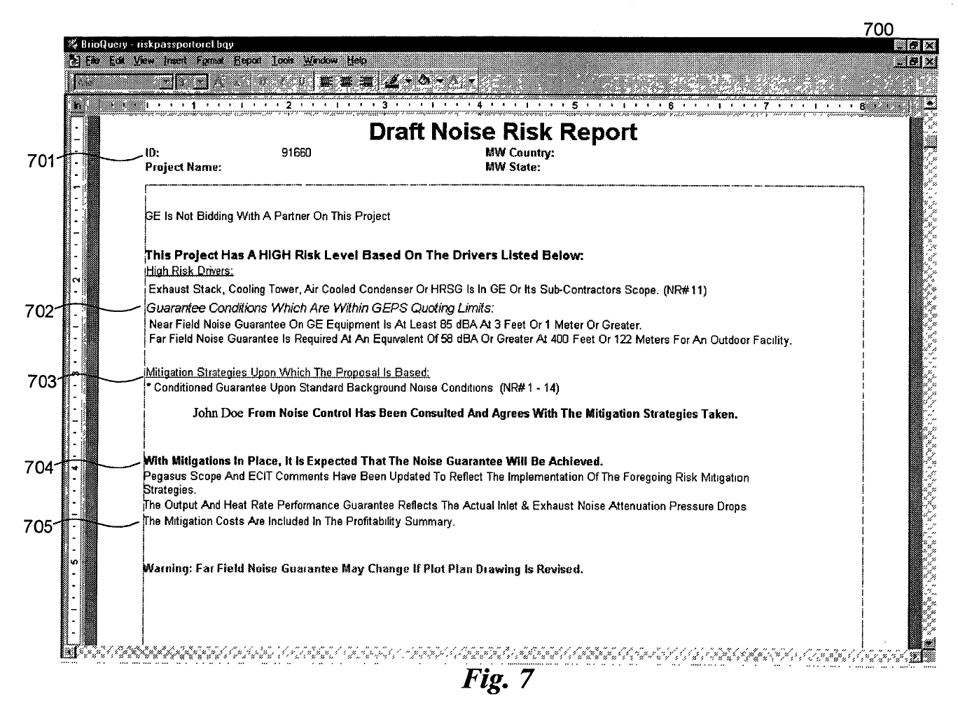

FIG. 7 is a display page illustrating a risk report in one embodiment. This report provides a summary of the risk data, high risk factors, and mitigating factors for a risk type of the project. A display page 700 includes a project identification section 701, a high risk drivers section 702, a mitigating factor section 703, and an analyst section 704. The risk assessment system may generate a similar report for each a risk type associated with the project. The risk assessment system may also provide a risk assessment summary report that summarizes the information in the risk reports. These reports may then be provided to the risk assessment team to assist in their analysis of the project.

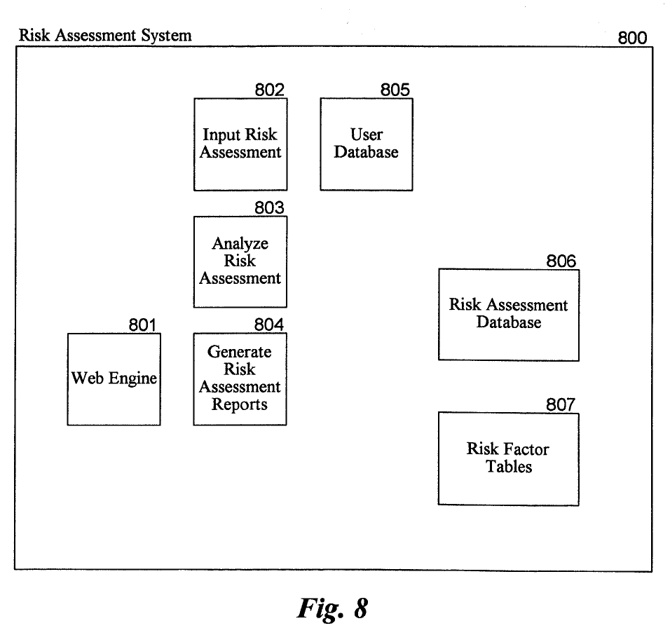

FIG. 8 illustrates components of the risk assessment system in one embodiment. The risk assessment system may provide a web-based interface through which the user can enter and view the risk assessment data. One skilled in the art will appreciate that the risk assessment system can be implemented in other environments such as a client/server environment in which the risk assessment software executes on a client computer and accesses and database on a server computer that stores the risk assessment data. The risk assessment system includes a web engine 801, an input risk assessment component 802, an analyze risk assessment component 803, a generate risk assessment reports component 804, a user database 805, a risk assessment database 806, and risk factor tables 807. The web engine receives requests, such as HTTP requests, from client computers and invokes the appropriate component of the risk assessment system to service the request and provide responses, such as HTTP responses. The input risk assessment component coordinates the entry of the project information, project detail information, and risk data for project. The input risk assessment data stores the risk data in the risk assessment database. Each project may be identified by a unique project identifier. The analyze risk assessment component applies the rules for the risk factors of risk types to the risk assessment data to identify the high risk factors and then identifies the mitigating factors. The generate risk assessment reports component compiles the risk assessment data and generates the risk reports for the risk assessment team. The user database may contain an entry for each user authorized to use the risk assessment system. The database may include a user name and password of each user for authentication and authorization purposes. Each user may have different levels of authority. For example, one user may have authority to create a new project, while another user (e.g., a risk assessment analyst) may have authority to approve or disapprove for a certain risk type (e.g., noise level). The risk factor tables may include various tables that identify risk factors and mitigating factors for each risk type. One skilled in the art will appreciate that the risk assessment system may be implemented by hard-coding the rules in a program that applies the rules to the risk data.

The risk assessment system may execute on a computer system that includes a main memory, a central processing unit, input devices (e.g., keyboard and pointing device), output devices (e.g., display devices), and storage devices, such as a hard drive, a CD-ROM, or a floppy disk drive. The main memory and storage devices are computer-readable media that may contain instructions for implementing the risk assessment system. Also, one skilled in the art will appreciate that various communication channels such as the Internet, a wide area network, or a point-to-point, dial-up connection can be used to interconnect the risk assessment system with a client computer.

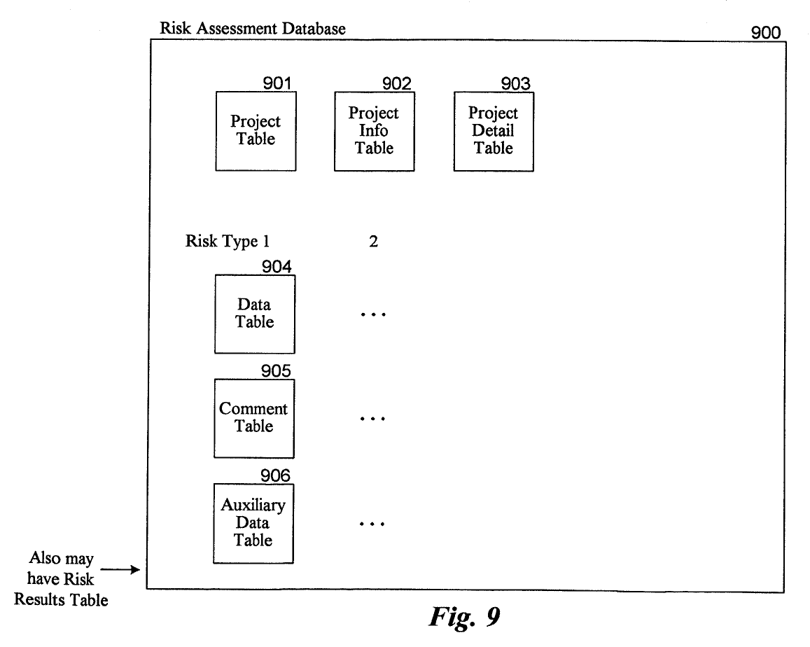

FIG. 9 is a block diagram illustrating the organization of the risk assessment database in one embodiment. The risk assessment database includes a project table 901, a project information table 902, and a project detail table 903. Each of these tables may have an entry for each project that contains the corresponding data. The risk assessment database may also have a data table 904, a comment table 905, and an auxiliary data table 906. The data table may contain an entry for each project that contains the risk data associated with that risk type for that project. The comment table may contain an entry for each project that contains various comments provided by an analyst for that risk type. The auxiliary data table may contain an entry for each project that identifies as auxiliary data to be included with the risk report for that risk type. For example, the auxiliary data may include a spreadsheet developed by the person proposing the contract, a graph illustrating profit margins associated with related contracts, and so on. One skilled in the art will appreciate that the tables of this risk assessment database illustrate the logical organization of risk assessment data. The actual design of a risk assessment database may take advantage of well-known techniques to meet the speed requirements, response time requirements, and other requirements of a particular implementation of the risk assessment system.

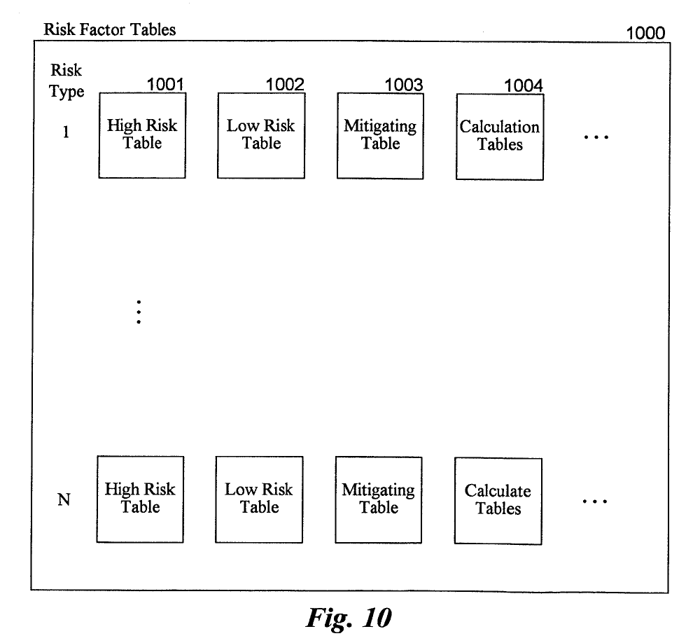

FIG. 10 is a block diagram illustrating various risk factor tables in one embodiment. The risk factor tables 1000 may have a collection of tables for each risk type. The tables may include a high risk factors table 1001, a low risk factors table 1002, a mitigating factors table 1003, and a calculations table 1004. The high risk factors table may identify both the high risk factors (or high risk drivers) for the risk type and the rules for determining whether the high risk factor applies to a particular project. The low risk factors table may identify the low risk factors for the risk type. The mitigating factors table may identify the mitigating factors and the high risk factors to which they apply. The calculations table may contain information describing how to calculate certain values (e.g., maximum noise level of certain piece of equipment).

Table 1 illustrates a high risk factors table for a noise level risk type in one embodiment. The table contains an entry for each high risk factor that includes text describing the high risk factor and a rule for applying the high risk factor. For example, high risk factor number 10 has the text “The far field guarantees do not reference a plot plan drawing, number, date, and revision. (NR# 10)” and a rule that indicates that the high risk factor applies when the project has “a far field and there is no plot plan referenced.”

TABLE 1
High Risk Factors

| # | Factor | Rule |
|---|---|---|
| 1 | Guarantee is based on maximum sound pressure | True if we guarantee maximum SPL |
| | levels and not on average sound pressure levels. | |
| | (NR# 1) | |
| 2 | Guarantee is based on octave band sound pressure | True if we guarantee octave band |
| | levels or noise curves and not on a single dba value. | SPL |
| | (NR# 2) | |
| 3 | Guarantee is based on start-up and/or transient noise | True if we guarantee start-up transient |
| | and not on base/peak load operation. (NR# 3) | noise |
| 4 | Guarantees are based on individual equipment or | True if we guarantee individual |
| | components (e.g. inlet, exhaust). (NR# 4) | equipment or components |
| 5 | Near field noise guarantee is less than 85 or 80 dba at | True if we have a near field, and we |
| | three feet or one meter. (NR# 5) | the guarantee value is less than 80/ |
| | | 85 dba depending on the packages |
| 6 | Near field noise guarantee is for indoor units where | True if we have a near field, there are |
| | the building is not in the company's scope. (NR# 6) | indoor units, and we do not provide |
| | | the building |
| 7 | Far field noise guarantee is required at less than 200 | True if we have a far field and the |
| | feet or at an unidentified distance/plant boundary. | guarantee distance is less than 200 |
| | (NR# 7) | feet or is unknown |
| 8 | Far field noise guarantee is required at an equivalent | True if we have a far field, the units |
| | of less than calculated value dba at 400 feet or 122 | are outdoors, and the guarantee value |
| | meters for an outdoor facility. (NR# 8) | is less than calculated dba depending |
| | | on the packages |
| 9 | Far field noise guarantee is required at an equivalent | True if we have a far field, the units |
| | of less than calculated value dba at 400 feet or 122 | are indoors and the guarantee value |
| | meters for an indoor facility. (NR# 9) | is less than calculated dba depending |
| | | on the packages |
| 10 | The far field guarantees do not reference a plot plan | True if we have a far field and there is |
| | drawing, number, date, and revision. (NR# 10) | no plot plan referenced |
| 11 | Exhaust stack, cooling tower, air-cooled condenser, or | True if we have a far field and we are |
| | hrsg is in the company's or its sub-contractor's scope. | providing the equipment referenced |
| | (NR# 11) | |
| 12 | Far field guarantee is required for an equipment only | True if we have a far field and the |
| | proposal. (NR# 12) | proposal is equipment only |
| 13 | Partner's acoustic design capability is unknown. | True if we have a far field, a partner, |
| | (NR# 13) | and the partner has not been |
| | | evaluated |
| 14 | Partner's acoustic design capability does not meet the | True if we have a far field, a partner, |
| | company's standards. (NR# 14) | the partner has been evaluated and |
| | | the partner does not meet the |
| | | company's standards |

Table 2 illustrates a low risk factor table for a noise level risk type in one embodiment. The table contains an entry for each low risk factor that includes text describing the low risk factor and a rule for applying the low risk factor. For example, the first entry has the text “near field noise guarantee on the company's equipment is at least [calculated value] dba at three feet or one meter or greater.” The entry also includes a rule indicating that this low risk factor applies when the near field guarantee is greater than a certain noise level.

TABLE 2
Low Risk Factors

| # | Factors | Rule |
|---|---|---|
| 1 | Near field noise guarantee on the company's | True if we have a near field, and the |
| | equipment is at least calculated value dba at three | guarantee value is greater than 80 |
| | feet or one meter or greater. | or 85 dba depending on the |
| | | packages |
| 2 | Far field noise guarantee is required at an equivalent | True if we have a far field, the units |
| | of calculated value dba or greater at 400 feet or 122 | are outdoors and the guarantee |
| | meters for an outdoor facility, | value is greater than calculated dba |
| | | depending on the packages |
| 3 | Far field noise guarantee is required at an equivalent | True if we have a far field, the units |
| | of calculated value dba or greater at 400 feet or 122 | are indoors, and the guarantee value |
| | meters for an indoor facility, | is greater than calculated dba |
| | | depending on the packages |

Table 3 illustrates a mitigating factors table for a noise level risk type in one embodiment. The table contains an entry for each mitigating factor that includes text describing the mitigating factor and to which factor it applies. For example, the 13th entry has the text “For far field guarantees, ensure that the proposal/contract guarantees reference a plot plan drawing, number, date, and revision (NR# 7-10).” The corresponding rule indicates that this mitigating factor applies whenever high risk factors 7, 8, 9, or 10 apply to the project.

TABLE 3
Mitigating Factors

| # | Factor | Rule |
|---|---|---|
| 1 | Immediately consult with a noise control engineer for assistance. (See | True for high |
| | risk management home page to identify engineers.) (NR# 1-14) | risk 1-14 |
| 2 | Condition guarantee upon standard background noise conditions. | True for high |
| | (NR# 1-14) | risk 1-14 |
| 3 | Restructure guarantees to average noise levels at base/peak load | True for high |
| | using arithmetic average of eight points and exclude guarantees of | risk 1-4 |
| | maximum noise levels, octave bands, or start-up/transient noise level | |
| | guarantees. (NR# 1-4) | |
| 4 | Condition near field guarantee on “free field” conditions or for | True for high risk 6 |
| | appropriate units (6b, 6fa, 9e), provide lower sound packaging. | |
| | (NR# 6) | |
| 5 | Take exception to customer requested sound pressure levels and | True for high |
| | quote a sound pressure level attainable by company. (NR# 5, 7-9) | risk 5, 7, 8, 9 |
| 6 | For indoor equipment where a third party (including a partner) is | True for high risk 6 |
| | providing the building, condition the company's near field noise | |
| | guarantee or commitment on the company's expectations regarding | |
| | minimum absorption of building walls and roof. (NR# 6) | |
| 7 | Add additional noise attenuation in the inlet or exhaust systems or | True for high risk 9 |
| | other equipment as required. (NR# 9) | |
| 8 | Define the equipment package's sound pressure level contribution to | True for high |
| | the far field noise guarantee. (NR# 12-14) | risk 12, 13, 14 |
| 9 | Get quotes from third parties where individual equipment or | True for high risk 4 |
| | component noise guarantees are required. (NR# 4) | |
| 10 | To achieve a noise guarantee of less than value from input dba at | True for high risk 8, 9 |
| | 400 feet or 122 meters or less for an indoor or outdoor facility, use a | |
| | building, additional silencing or other structures to attenuate noise. | |
| | (NR# 8, 9) | |
| 11 | Since the company's scope includes a building, exhaust stack, | True for high risk 11 |
| | cooling tower, air cooled condenser, or hrsg, obtain bids on such | |
| | scope with identical noise guarantees prior to proposal submission to | |
| | ensure correct costs for noise control. (NR# 11) | |
| 12 | Obtain back to back noise guarantees from sub-contractors who are | True for high risk 11 |
| | providing the building, exhaust system, cooling tower, air cooled | |
| | condenser, HRSG. (NR# 11) | |
| 13 | For far field guarantees, ensure that the proposal/contract guarantees | True for high |
| | reference a plot plan drawing, number, date, and revision. (NR# 7-10) | risk 7, 8, 9, 10 |
| 14 | Since partners noise attenuation capability has not yet been | True for high |
| | assessed, or does not meet standards, review the partner's | risk 13, 14 |
| | capabilities with a noise control engineer prior to bid submission. | |
| | (NR#13,14) | |
| 15 | Condition noise guarantee on separately stated individual equipment | True for high risk 4 |
| | or component noise guarantees (e.g. inlet, exhaust). (NR# 4) | |
| 16 | Take exception to far field noise guarantee where the company is | True for high risk 12 |
| | only providing equipment. (NR# 12) | |

Table 4 illustrates a calculations table for maximum far field noise levels in one embodiment. The table contains a maximum far field noise level associated with each type of equipment and configuration that can be included in a project. in this example, the maximum far field noise level is based on the type of combined cycle equipment and the number of blocks. For example, the combined cycle equipment identified by “STAG 106B” with four blocks has a maximum far field noise value of 76 decibels.

TABLE 4
Maximum Noise Level

Blocks

| Combined Cycle | 1 | 2 | 3 | 4 | 5 | 6 |
|---|---|---|---|---|---|---|
| STAG 106B | 70 | 73 | 75 | 76 | 77 | 78 |
| STAG 106FA | 70 | 73 | 75 | 76 | 77 | 78 |
| STAG 107EA | 69 | 72 | 74 | 75 | 76 | 77 |
| STAG 107FA | 68 | 71 | 73 | 74 | 75 | 76 |
| STAG 107FB | 68 | 71 | 73 | 74 | 75 | 76 |
| STAG 107H | 66 | 69 | 71 | 72 | 73 | 74 |
| STAG 109E | 71 | 74 | 76 | 77 | 78 | 79 |
| STAG 109FA | 66 | 69 | 71 | 72 | 73 | 74 |
| STAG 109H | 66 | 69 | 71 | 72 | 73 | 74 |
| STAG 206B | 71 | 74 | 76 | 77 | 78 | 79 |
| STAG 206FA | 73 | 76 | 78 | 79 | 80 | 81 |
| STAG 206FB | 73 | 76 | 78 | 79 | 80 | 81 |
| STAG 207EA | 72 | 75 | 77 | 78 | 79 | 80 |
| STAG 207FA | 71 | 74 | 76 | 77 | 78 | 79 |
| STAG 209E | 74 | 77 | 79 | 80 | 81 | 82 |
| STAG 209FA | 69 | 72 | 74 | 75 | 76 | 77 |
| STAG 307EA | 75 | 78 | 80 | 81 | 82 | 83 |
| STAG 307FA | 74 | 77 | 79 | 80 | 81 | 82 |
| STAG 307FB | 74 | 77 | 79 | 80 | 81 | 82 |
| STAG 309E | 77 | 80 | 82 | 83 | 84 | 85 |
| STAG 309FA | 72 | 75 | 77 | 78 | 79 | 80 |
| STAG 407EA | 77 | 80 | 82 | 83 | 84 | 85 |
| STAG 407FA | 76 | 79 | 81 | 82 | 83 | 84 |
| STAG 407FB | 76 | 79 | 81 | 82 | 83 | 84 |
| STAG 409FA | 74 | 77 | 79 | 80 | 81 | 82 |

Table 5 illustrates a calculations table for adjusting the maximum far field noise levels in one embodiment. This table contains information describing how to adjust the maximum far field noise level for a certain configuration of equipment based on location of the equipment. For example, the first entry indicates to subtract one decibel if the gas turbine or steam turbine is located indoors.

TABLE 5
Location Noise Level Adder

If Gas Turbine OR Steam Turbine is Indoors, −1 dba
If Gas Turbine AND Steam Turbine is Indoors, −2 dba
If HRSG is Indoors, −1 dba
If GT AND ST AND HRSG is Indoors, −3 dba

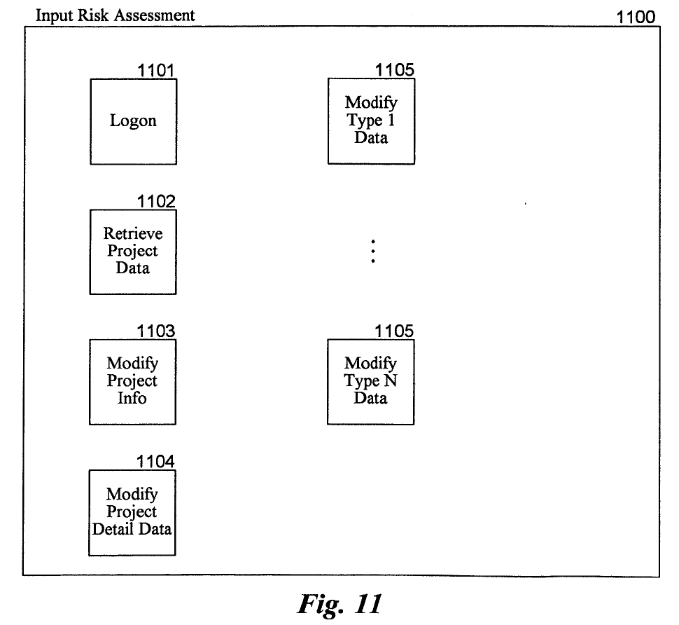

FIG. 11 is a block diagram illustrating components of the input risk assessment component in one embodiment. The input risk assessment component 1100 includes a logon component 1101, a retrieve project data component 1102, a modify project data component 1103, a modify project detail data 1104, and a modify risk type data component 1105 for each possible risk type. The logon component performs user authentication and may identify the authorization level of a user. The retrieve project data component retrieves the data for a project from the risk assessment database. The modify project data component allows a user to add or modify data relating to a project. The modify project detail data component allows a user to add or modify detail data associated with the project. The modify risk data component allows the user to add or modify the risk data associated with each risk type. One skilled in the art will appreciate that the risk assessment system may be organized very differently depending on design choices of the developers. These components represent one possible logical organization of the risk assessment system.

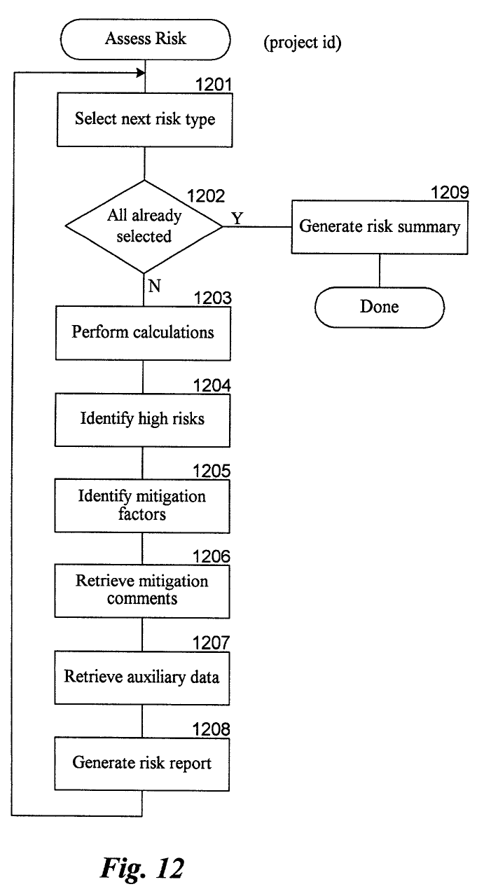

FIGS. 12-18 are flow diagrams illustrating processing of the risk assessment system in one embodiment. FIG. 12 is flow diagram illustrating the processing of the assess risk component in one embodiment. The component is invoked to identify the high risk factors, low risk factors, and mitigating factors for a project. The component is passed the project identifier. The component initially retrieves the project data for the identified project from the risk assessment database. In blocks 1201-1208, the component loops processing each risk type. In block 1201, the component selects the next risk type. In decision block 1202, if all the risk types have already been selected, then the component continues at block 1209, else the component continues at block 1203. In block 1203, the component performs the calculations associated with the selected risk type. For example, the component may calculate the maximum far field noise level for the configuration of the equipment proposed in the contract. The component may invoke a routine developed to perform the calculations for the selected risk type in one embodiment. Alternatively, the component may perform the calculation specified in the calculations table for the selected risk type. In block 1204, the component identifies the high risk factors by applying the rules specified in the high risk factors table. The component also identifies the low risk factors. In block 1205, the component identifies the mitigating factors for the high risk factors using the mitigating factors table. In block 1206, the component retrieves any mitigating factor comments provided by an analyst from the comments table. In block 1207, the component retrieves the auxiliary data for the selected risk type. In block 1208, the component generates the risk report for the selected risk type and then loops to block 1201 to select the next risk type. In block 1209, the component generates a risk summary report for the project and then completes.

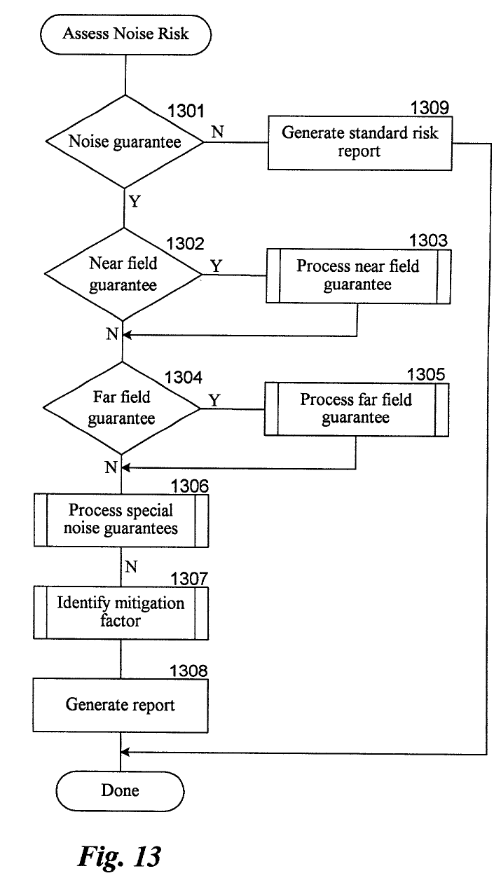

FIGS. 13-18 are flow diagrams illustrating the processing to assess the risk of noise level in one embodiment. In this embodiment, the rules associated with identifying high risk factors are hard-coded into a program. FIG. 13 is a flow diagram illustrating the processing of an assess noise risk component in one embodiment. This component is passed noise level related data for a project. In decision block 1301, if the project includes a noise level guarantee, then the component continues at block 1302, else the component continues at block 1309. In decision block 1302, if this project has a near field noise level guarantee, then the component invokes the process near field guarantee component in block 1303. In block 1304, if this project has a far field noise level guarantee, then the component invokes the process far field guarantee component in block 1305. In block 1306, the component invokes the process special noise guarantee component. In block 1307, the component invokes the identify mitigating factors component 1307. In block 1308, the component generates the risk report for the noise level risk type and then completes. In block 1309, the component generates a standard risk report for the noise level and the completes.

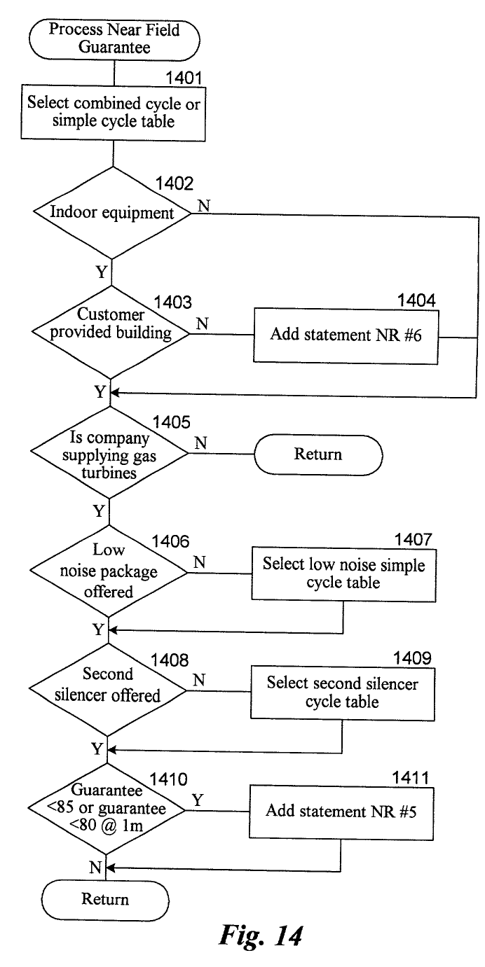

FIG. 14 is a flow diagram illustrating the processing of the process near field guarantee component in one embodiment. In block 1401, the component selects a combined cycle or simple cycle calculation table. These tables contain the maximum noise level associated with the equipment. In decision block 1402, if the equipment is to be installed indoors, then the component continues at block 1403, else the component continues at block 1405. In decision block 1403, if the customer is providing the building, then the component continues at block 1405, else the component identifies that high risk factor number six applies in a block 1404. In decision block 1405, if the company is supplying a gas turbines, then the component continues at block 1406, else the component has completed its processing and returns. In decision block 1406, if a low noise package is being offered, then the component continues at block 1407, else the component continues at block 1408. In block 1407, the component selects a low noise simple cycle table that contains the maximum noise levels associated with the low noise package. In decision block 1408, if the equipment includes a second silencer, then the component continues at block 1409, else component continues at block 1410. In block 1409, the component selects a second silencer cycle table that contains the maximum noise levels associated with the second silencer package. In decision block 1410, if the guarantee near field noise level is greater than 85 or greater than 80 at one meter, then the component identifies that high risk factor number five applies. The component then returns.

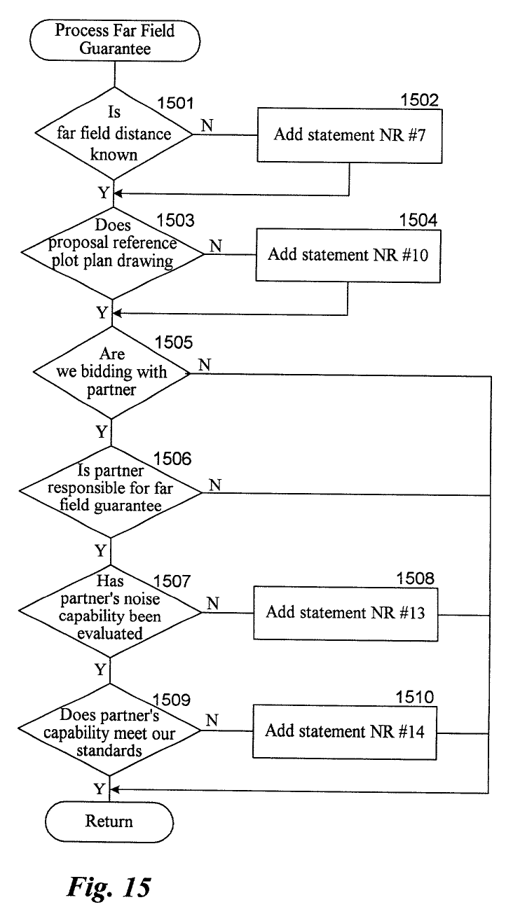

FIG. 15 is a flow diagram illustrating the processing of the process far field guarantee component in one embodiment. In decision block 1301, if the far field distance is not known, then the component identifies high risk factor number 7 in block 1502. In decision block 1503, if no plot plan is referenced in the contract, then the component identifies that high risk factor number 10 applies in block 1504. In decision block 1505, if the project specifies a bidding partner, then the component continues at block 1506, else the component returns. In decision block 1506, if the partner is responsible for the far field guarantee, then the component continues at block 1507, else the component returns. In decision block 1507, if the partner's noise level capability has not been evaluated, then the component identifies high risk factor number 13 in block 1508 and then returns. In decision block 1509, if the partner's noise level capabilities do not meet the company's standards, then the component identifies high risk factor number 14. The component then returns.

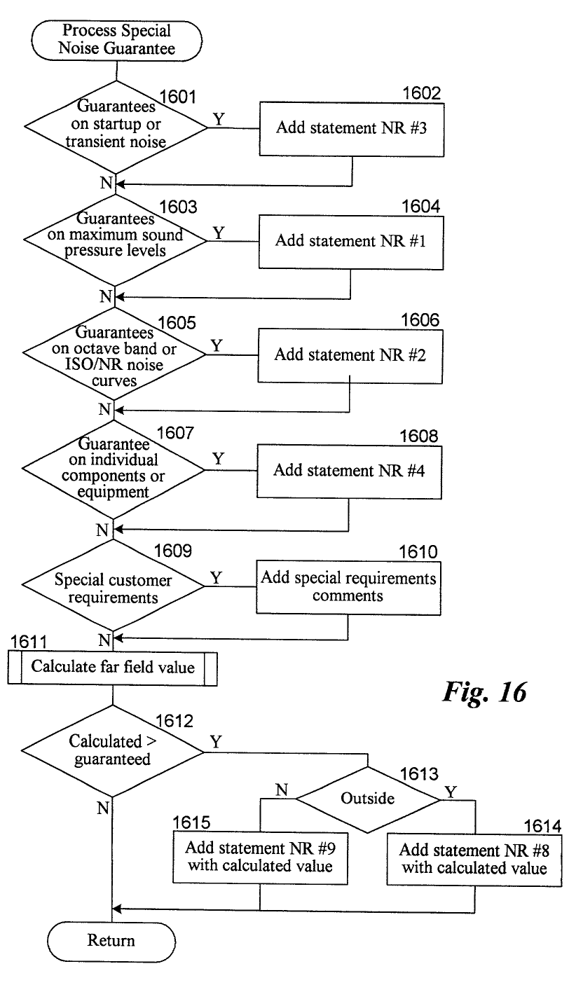

FIG. 16 is a flow diagram illustrating the processing of the process special noise guarantee component in one embodiment. In decision block 1601, if there are guarantees on startup or guarantees with respect to transient noise, then the component identifies high risk factor number 3 in block 1602. In decision block 1603, if there are maximum sound pressure level guarantees, then the component identifies high risk factor number 1 in block 1604. In decision block 1605, if there are guarantees as to octave or noise curves, then the component identifies high risk factor number in block 1606. In decision block 1607, if there are guarantees on individual components of the equipment, then the component identifies high risk factor number 4 in block 1608. In decision block 1609, if there are special customer requirements, then the customer identifies the special requirement comments in a block 1610. In block 1611, the component invokes the calculate far field value component to calculate the maximum far field noise level for the equipment. In decision block 1612, if the maximum far field noise level is greater than the guarantee noise level, then the component continues at block 1613, else the component returns. In decision block 1613, if the equipment is outside, then the component identifies high risk factor number 8 in block 1614, else the component identifies high risk factor number 9 in block 1615. The component then returns.

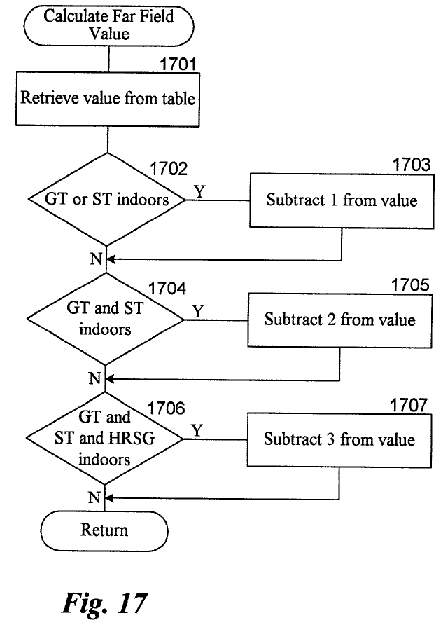

FIG. 17 is a flow diagram illustrating the processing of the calculate far field value component in one embodiment. In block 1701, the component retrieves the maximum far field value from the calculation table for the particular equipment configuration. In decision block 1702, if the gas turbine or steam turbine is indoors, then the component subtracts 1 from the retrieved value in block 1703. In decision block 1704, if both the gas turbine in the steam turbine are indoors, then the component subtracts 2 from the retrieved value in block 1705. In decision block 1706, if the gas turbine, steam turbine, and heat recovery steam generator are all indoors, then the component subtracts 3 from the retrieved value. The component then returns.

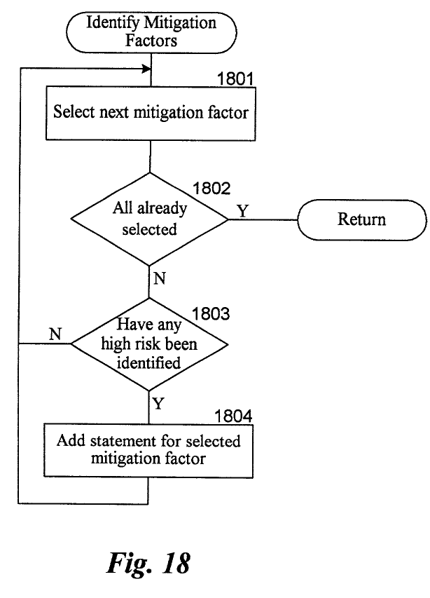

FIG. 18 is a flow diagram illustrating processing of the identify mitigating factors component in one embodiment. The component loops selecting each mitigating factor for a risk type and determines whether that mitigating factor applies to any of the identified high risk factors. In block 1801, the component selects the next mitigating factor. In decision block 1802, if all the mitigating factors have already been selected, then the component returns, else component continues at block 1803. In decision block 1803, if any high risk factors associated with the selected mitigating factor have been identified, then the component identifies the selected mitigating factor in block 1804 and loops to block 1801 to select the next mitigating factor.

From the above description, it will be appreciated that although specific embodiment of the risk assessment system have been described for purposes of illustration, various modifications may be made without deviating from the scope of the invention. Accordingly, the invention is not limited except by the following claims.

1. A method in a computer system for assessing risk of a project, the method comprising:
for each of a plurality of risk types,
providing rules for one or more risk factors for determining whether each risk factor is high; and
providing one or more mitigating factors for a risk factor;
receiving information describing the project, the information including data relating to each risk type;
for each of the plurality of risk types,
identifying risk factors that have a high risk by applying the provided rules to the data for the risk type; and
identifying mitigating factors that apply to the identified risk factors; and
generating a risk assessment report that includes the identified risk factors and identified mitigating factors.

2. The method of claim 1 wherein the information describing the project includes overall project information and detailed project information.

3. The method of claim 1 wherein the provided rules are provided by software that implements each rule.

4. The method of claim 1 wherein the provided rules are provided by a rules engine that applies rules from a rules table.

5. The method of claim 1 wherein indications of the identified risk factors and identified mitigating factors are persistently stored.

6. The method of claim 5 including receiving an analysis of the identified risk factors and mitigating factors for a risk type from a user designated to provide analyses for that risk type.

7. The method of claim 6 wherein the generated risk assessment report includes the received analysis.

8. The method of claim 1 including receiving auxiliary data for a risk type.

9. The method of claim 8 wherein the generated risk assessment report includes the received auxiliary data.

10. The method of claim 8 wherein the auxiliary data is in a spreadsheet format.

11. The method of claim 8 wherein the auxiliary data is in a graph format.

12. The method of claim 1 wherein the project is defined by a proposed contract.

13. A computer system for assessing risk of a project, comprising:
a rules component having rules for risk factors for determining whether each risk factor is high and having mitigating factors for a risk factor;
a data input component that receives information describing the project, the information including data relating to the risk factors; and
an analysis component that identifies risk factors that have a high risk by applying the rules to the data and that identifies mitigating factors that apply to the identified risk factors.

14. The computer system of claim 13 including a report component that generates a risk assessment report listing the identified risk factors and the identified mitigating factors.

15. The computer system of claim 13 wherein the information describing the project includes overall project information and detailed project information.

16. The computer system of claim 13 wherein the rules are provided by software that implements each rule.

17. The computer system of claim 13 wherein the rules are provided by a rules engine that applies rules from a rules table.

18. The computer system of claim 13 wherein indications of the identified risk factors and identified mitigating factors are persistently stored.

19. The computer system of claim 18 wherein the risk factors and mitigating factors are categorized by risk type and including an analyst component that receives an analysis of the identified risk factors and mitigating factors for a risk type from a user designated to provide analyses for that risk type.

20. The computer system of claim 19 wherein the received analysis is included in a risk assessment report that lists the high risk factors and mitigating factors.

21. The computer system of claim 13 including a component that receives auxiliary data for a risk type.

22. The computer system of claim 21 wherein the received auxiliary data is included in a risk assessment report that lists the high risk factors and mitigating factors.

23. The computer system of claim 21 wherein the auxiliary data is in a spreadsheet format.

24. The computer system of claim 21 wherein the auxiliary data is in a graph format.

25. The computer system of claim 13 wherein the project is defined by a proposed contract.

26. A computer-readable medium containing instructions for controlling a computer system to assess risks of a project, by a method comprising:
for each of a plurality of risk types, providing rules for one or more risk factors for determining whether each risk factor is high;
receiving information describing the project, the information including data relating to each risk type;
for each of the plurality of risk types, identifying risk factors that have a high risk by applying the provided rules to the data for the risk type; and
generating a risk assessment report that includes the identified risk factors.

27. The computer-readable medium of claim 26 wherein the information describing the project includes overall project information and detailed project information.

28. The computer-readable medium of claim 26 wherein the provided rules are provided by software that implements each rule.

29. The computer-readable medium of claim 26 wherein the provided rules are provided by a rules engine that applies rules from a rules table.

30. The computer-readable medium of claim 26 including identifying mitigating factors that apply to the identified risk factors wherein indications of the identified risk factors and identified mitigating factors are persistently stored.

31. The computer-readable medium of claim 30 including receiving an analysis of the identified risk factors and mitigating factors for a risk type from a user designated to provide analyses for that risk type.

32. The computer-readable medium of claim 31 wherein the generated risk assessment report includes the received analysis.

33. The computer-readable medium of claim 26 including receiving auxiliary data for a risk type.

34. The computer-readable medium of claim 33 wherein the generated risk assessment report includes the received auxiliary data.

35. The computer-readable medium of claim 33 wherein the auxiliary data is in a spreadsheet format.

36. The computer-readable medium of claim 33 wherein the auxiliary data is in a graph format.

37. The computer-readable medium of claim 26 wherein the project is defined by a proposed contract.
